(19) United States
(12) Patent Application Publication
(10) Pub. No.: US 2014/0222765 A1
(43) Pub. Date: Aug. 7, 2014

(54) Method, System and Client Terminal for Restoring Operating System

(71) Applicant: Peixuan Chen, Shenzhen (CN)

(72) Inventor: Peixuan Chen, Shenzhen (CN)

(73) Assignee: Tencent Technology (Shenzhen) Company Ltd., Shenzhen (CN)

(21) Appl. No.: 14/343,075

(22) PCT Filed: Jul. 20, 2012
(86) PCT No.: PCT/CN2012/078930

§ 371 Date: Mar. 6, 2014

(30) Foreign Application Priority Data
Sep. 15, 2011 (CN) 201110273457.6

(51) Int. Cl. G06F 11/14

(52) U.S. Cl. CPC G06F 11/1464
USPC 707/679

(57) ABSTRACT

A method for restoring an operating system in a computer is provided. The method includes comparing local operating system files of the computer with standard operating system files stored in a cloud server, and obtaining results of the comparison; retrieving portions or a complete set of the standard operating system files from the cloud server based on the results of the comparison; updating the local operating system files with the standard operating system files retrieved from the cloud server; and restoring the operating system in the computer by reloading the updated local operating system files.

### FIELD OF THE INVENTION

The present invention relates generally to an operating system, and more particularly to method, system and client terminal for restoring an operating system of a computer.

### BACKGROUND OF THE INVENTION

It is well known that an operating system of a computer is an essential platform for various application programs Due to software updates, computer virus infection and many other reasons, an operating system of a computer may need being restored or reloaded from time to time. Conventionally, there are three methods available and used for restoring an operating system of a computer:

System disk installation: the operating system is re-installed with original operating system installation disks. This approach requires the steps of initiating the disk drives, formatting the hard drives, and copying the operating system files.

Ghost imaging installation: the operating system is re-installed with a ghost image, which is a mirror image of the operating system pre-installed in a computer.

System backup restoration: the operating system is re-installed with backup files. When the computer was initially setup or during normal operation, a backup of the entire operation system files is created in a local hard drive or external hard drive. When there is a need, the backup files from the local hard drive or external hard drive are used to restore the operating system by certain backup and restore programs.

Practically, each of the approaches has disadvantages. For example, for the system disk installation, it is very cumbersome and time-consuming to reload all original system files. In addition, once the original system files are reloaded, there is usually a need to install drivers, patches, and re-install all application programs. The ghost image installation is relatively quicker than the system disk installation, but currently-available ghost imaging systems may contain rogue software or preset backdoors for hackers. Even if anti-virus software is installed in the computer, sometime it is still not enough to remove all potential security risk. On the other hand, the ghost image files are often in sizes of multi gigabytes (GB), and require a large amount of storage space. It is also time-consuming to download the ghost image files back in the computer. For the system backup restoration, the backup files are stored on the local computer and take up a relatively large hard disk space.

Therefore, a heretofore unaddressed need exists in the art to address the aforementioned deficiencies and inadequacies.

### SUMMARY OF THE INVENTION

In one aspect, the present invention relates to a method for restoring an operating system in a computer. In one embodiment, the method includes comparing local operating system files of the computer with standard operating system files stored in a cloud server, obtaining results of the comparison, retrieving portions or a complete set of the standard operating system files from the cloud server based on the results of the comparison, updating the local operating system files with the standard operating system files retrieved from the cloud server, and restoring the operating system in the computer by reloading the updated local operating system files.

Further, the method includes, prior to restoring the operating system in the computer by reloading the updated local operating system files, enquiring the cloud server whether to contain user backup files of the local operating system files, retrieving the user backup files from the cloud server if the cloud server contains the user backup files, and updating the local operating system files with the user backup files retrieved from the cloud server.

In one embodiment, the step of obtaining the results of the comparisons includes obtaining information related to the standard operating system files stored in the cloud server that are different from the local operating system files, and information related to the standard operating system files stored in the cloud server that are not part of the local operating system files.

Additionally, at least one of the above steps is executed by at least one processor from the cloud server or a client terminal in commutation with the cloud server. In one embodiment, the client terminal is the computer in which the operating system is restored. In another embodiment, the client terminal is another computer rather than the computer in which the operating system is restored.

In another aspect, the present invention relates to an internet system for restoring an operating system of a computer. In one embodiment, the internet system has a cloud server storing standard operating system files and a client terminal. The cloud server is run by one or more processors. The client terminal includes a file comparing module configured to compare local operating system files of a computer with the standard operating system files stored in the cloud server and obtaining the results of the comparison, a file retrieving module configured to retrieve portions or a complete set of the standard operating system files from the cloud server based on the results of the comparison, a file updating module configured to update the local operating system files of the computer with the standard operating system files retrieved from the cloud server, and a system restoring module configured to restore the operating system by reloading the updated local operating system files of the computer.

In one embodiment, the results of the comparison obtained by the file comparing module comprise information related to the standard operating system files stored in the cloud server that are different from the local operating system files, and information related to the standard operating system files stored in the cloud server that are not part of the local operating system files.

In one embodiment, the cloud server is further adapted to store user backup operating system files of the client terminal. The client terminal further comprises a file enquiring module configured to enquire whether the cloud server contains the user backup operating system files. As such, in operation, the file enquiring module enquires whether the cloud server contains the user backup operating system files, the file retrieving module retrieves the user backup operating system files from the cloud server if the cloud server contains the user backup operating system files, and the file updating module updates the local operating system files of the computer with the user backup operating system files retrieved from the cloud server.

In one embodiment, the client terminal is the computer in which the operating system is restored. In another embodiment, the client terminal is another computer rather than the computer in which the operating system is restored.

In yet another aspect, the present invention relates to a client terminal for restoring an operating system of a computer. In one embodiment, the client terminal has a file comparing module configured to compare local operating system files of a computer with the standard operating system files stored in a cloud server and obtaining the results of the comparison, a file retrieving module configured to retrieve portions or a complete set of the standard operating system files from the cloud server based on the results of the comparison, a file updating module configured to update the local operating system files of the computer with the standard operating system files retrieved from the cloud server, and a system restoring module configured to restore the operating system by reloading the updated local operating system files of the computer, where at least one of the file comparing module, the file retrieving module, the file updating module and the system restoring module comprises a processor.

In one embodiment, the results of the comparison obtained by the file comparing module comprise information related to the standard operating system files stored in the cloud server that are different from the local operating system files, and information related to the standard operating system files stored in the cloud server that are not part of the local operating system files.

In one embodiment, the client terminal further has a file enquiring module configured to enquire whether the cloud server contains user backup operating system files. In operation, the file enquiring module enquires whether the cloud server contains the user backup operating system files, the file retrieving module retrieves the user backup operating system files from the cloud server if the cloud server contains the user backup operating system files, and the file updating module updates the local operating system files of the computer with the user backup operating system files retrieved from the cloud server.

In one embodiment, the client terminal is the computer in which the operating system is restored.

In another embodiment, the client terminal is another computer rather than the computer in which the operating system is restored.

In one embodiment, the client terminal is in communication with the cloud server via at least one of internet, intranet, wire and wireless communication protocols.

In a further aspect, the present invention relates to a computer-readable medium storing instructions which, when executed by a processor, cause a computer to perform a method for restoring an operating system of the computer. In one embodiment, the method comparing local operating system files of the computer with standard operating system files stored in a cloud server, obtaining results of the comparison, retrieving portions or a complete set of the standard operating system files from the cloud server based on the results of the comparison, updating the local operating system files with the standard operating system files retrieved from the cloud server, and restoring the operating system in the computer by reloading the updated local operating system files.

Further, the method includes, prior to restoring the operating system in the computer by reloading the updated local operating system files, enquiring the cloud server whether to contain user backup files of the local operating system files, retrieving the user backup files from the cloud server if the cloud server contains the user backup files, and updating the local operating system files with the user backup files retrieved from the cloud server.

In one embodiment, the step of obtaining the results of the comparisons includes obtaining information related to the standard operating system files stored in the cloud server that are different from the local operating system files, and information related to the standard operating system files stored in the cloud server that are not part of the local operating system files.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWING

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention.

FIG. 1 is a flow chart showing a method for restoring an operating system of a computer according to one embodiment of the present invention.

FIG. 2 is a flow chart showing a method for restoring an operating system of a computer according to another embodiment of the present invention.

FIG. 3 is a block diagram showing an internet system for restoring an operating system of a computer according to one embodiment of the present invention.

FIG. 4 is a block diagram showing a client terminal for restoring an operating system of a computer according to one embodiment of the present invention.

### DETAILED DESCRIPTION OF THE INVENTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

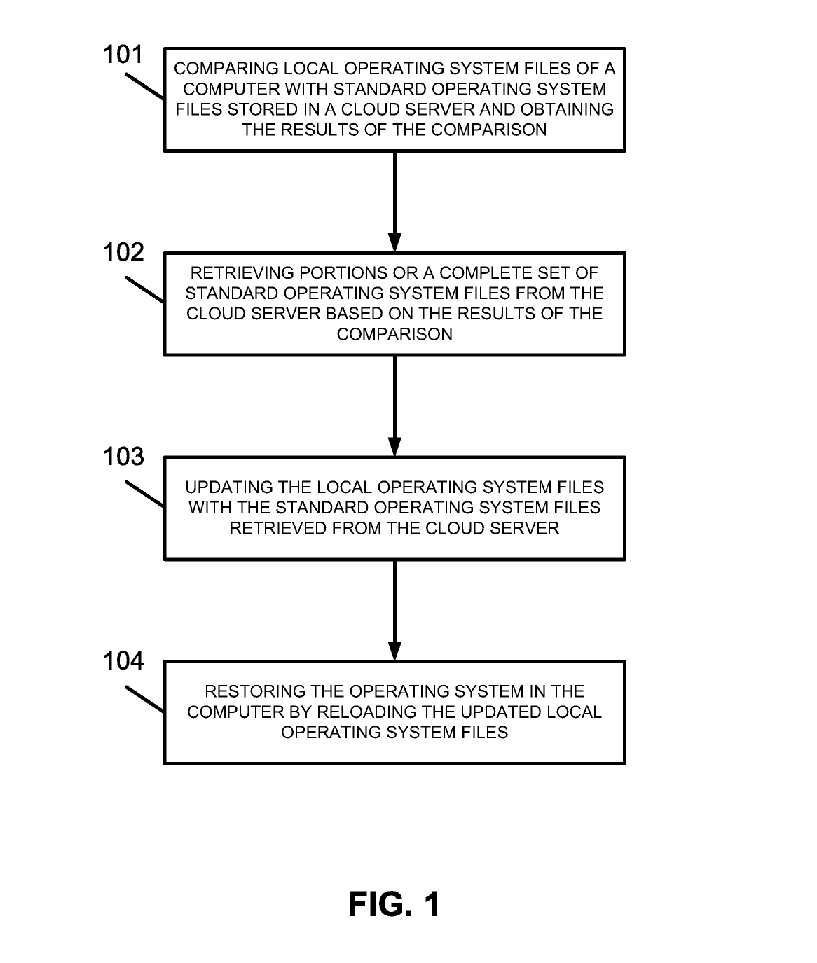

The description will be made as to the embodiments of the present invention in conjunction with the accompanying drawings in FIGS. 1-4. In accordance with the purposes of this invention, as embodied and broadly described herein, this invention, in one aspect, relates to a method for restoring an operating system of a computer, executed by one or more processors from a cloud server and/or a client terminal. The client terminal can be the computer in which the operating system is restored, or a terminal device such as another computer rather than the computer for which the operating system is restored. The cloud server may include at least one storage/database, and one or more processors/computers in communication with the at least one storage/database and at least one client terminal. The one or more processors/computers are configured to process/execute information when a request is received from, for example, a client terminal.

In this approach for restoring the operating system of the computer, a complete set of standard operating system files of the computer operating system is stored in the cloud server. Based on the standard operating system files, a user can perform online restoration of the operating system of the computer locally from the computer or remotely from another computer. The user can also perform a system backup to the cloud server. Accordingly, the time-consuming and cumbersome issues related to the conventional methods for restoring an operating system of a computer are solved.

Referring to FIG. 1, a flow chart of the method for restoring an operating system in a computer is shown according to one embodiment of the present invention. The method includes the following steps, which are executed by one or more processors from a cloud server and/or a client terminal.

At step 101, the local operating system files of the computer compared with standard operating system files stored in a cloud server run by, for example, one or more processors, and the results of the comparison is obtained. The local operating system files include all operating systems installed in the local computer, such as the Windows operating system installed in the local computer.

When a computer operating system is in a need of being restored, some local operating system files installed in the computer may have been damaged, removed, added or altered. The damaged, removed, added or altered operating system files are the ones that need to be reloaded. By comparing the local operating system files of the computer with the standard operating system files stored in the cloud server, information related to the standard operating system files stored in the cloud server that are different from the local operating system files, and information related to the standard operating system files stored in the cloud server that are not part of the local operating system files are obtained. Specifically, the information related to the standard operating system files stored in the cloud server that are different from the local operating system files identifies those files of the local operating system files that are damaged, added or altered, while the information related to the standard operating system files stored in the cloud server that are not part of the local operating system files identifies those files of the standard operating system files stored in the cloud server that are missed in the local operating system files of the computer.

The information may include in file size, file age, file-type frequency, directory size, namespace structure, file-system population, storage capacity and consumption, and degree of file modification etc.

Once the results of comparison are ready, the number and the names of the local operating system files to be replaced are determined.

Then, at step 102, portions or the complete set of the standard operating system files are retrieved from the cloud server based on the results of the comparison. Based on the information obtained from the comparison, the local computer retrieves the identified operating system files that are damaged, removed, added or altered from the cloud server. These retrieved files are used to replace the original damaged, removed, added or altered operating system files installed in the computer. Based on the comparison results, some of the original damaged, removed, added or altered operating system files are to be replaced completely, and some of the original damaged, removed, added or altered operating system files are to be replaced partially. Some of the retrieved files are to be added to the local computer operating system, and stored temporarily in the local hard drive for updating the local operating system files.

Next, the local operating system files are updated with the standard operating system files retrieved from the cloud server at step 103.

Finally, the operating system in the computer is restored by reloading the updated local operating system files at step 104.

In one embodiment, after step 103 and before step 104, as shown in FIG. 1, the method further includes the following steps: enquiring the cloud server whether to contain user backup files of the local operating system files at step 103a, retrieving the user backup files from the cloud server if the cloud server contains the user backup files at step 103b, and updating the local operating system files with the user backup files retrieved from the cloud server at step 103c.

Additionally, at least one of the above steps is executed by at least one processor from the cloud server or a client terminal in commutation with the cloud server. In one embodiment, the client terminal is the computer in which the operating system is restored. In another embodiment, the client terminal is another computer rather than the computer in which the operating system is restored.

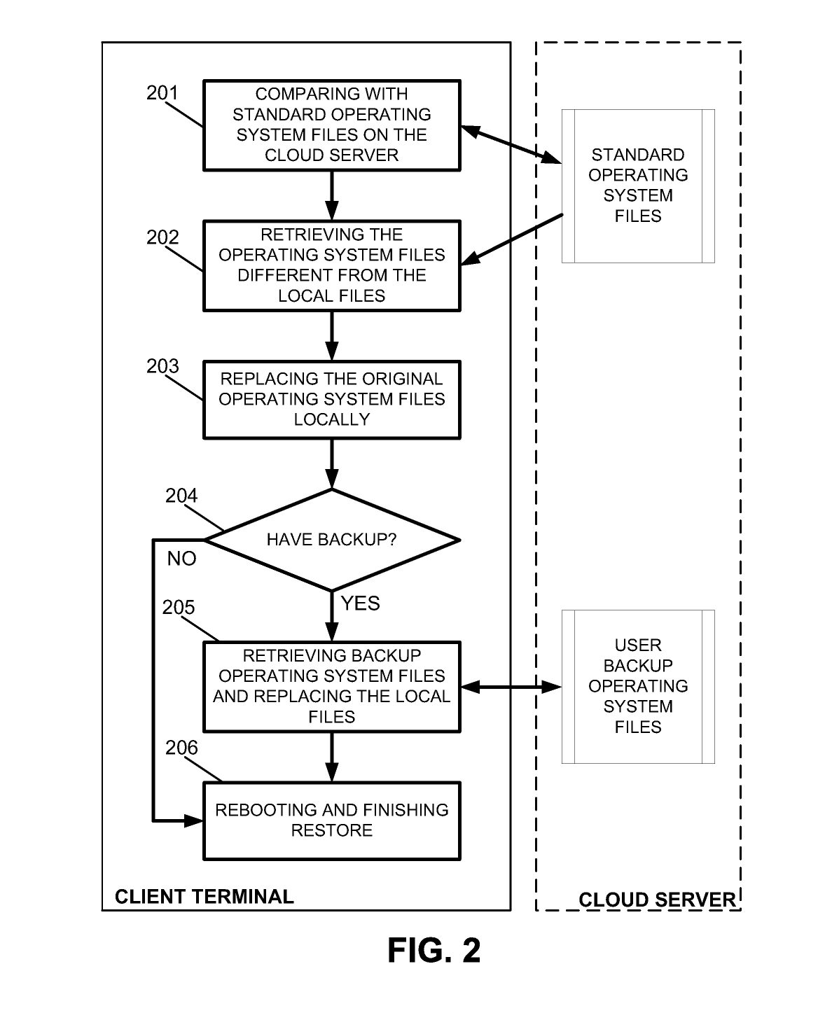

Referring to FIG. 2, a flow chart of the method for restoring an operating system of a computer is shown according to another embodiment of the present invention. The method is implemented with a client terminal (or a local computer) and a cloud server.

The cloud server stores the standard operating system files. When a user decides to make a backup of the local operating system files of the client terminal to the cloud server, the user can backup the local operating system files incrementally. The user only needs to backup any of the local operating system files that are different or missing from those in the cloud server. Such a backup does not require any local computer storage space.

The operating system is restored through the client terminal. In this exemplary embodiment shown in FIG. 2, the restoration of the operating system files through the client terminal includes the following steps:

At step 201, Md5 values of the local operating system files are compared with the Md5 values of the standard operating system files stored in the cloud server.

At step 202, files of the standard operating system files that have different Md5 values from those of the local operating system files, based on the comparison at step 201, and files of the standard operating system files that exist in the cloud server but not in the local operating system files are retrieved from the cloud server.

At step 203, the retrieved operating system files are copied to replace/update the corresponding operating system files installed in the local computer.

At step 204, the cloud server is queried to check whether there is a user backup of the operating system files to the cloud server. If the cloud server user contains such a backup of the operating system files, step 205 is performed. Otherwise, step 206 is performed.

At step 205, all backup operating system files are retrieved from the cloud server, and installed in the computer so as to replace/update the local operating system files.

At step 206: the operating system is restored with the updated operating system files.

According to the invention, the restoration of the operating system files is based on the set of standard operating system files stored in the cloud server. Therefore, when a user restores operating system files, he/she only needs to download the files that are different from the local operating system files. When the user backs up its operating system files, he/she only needs to upload the files that are different the corresponding files stored in the cloud server. Accordingly, the method saves time and resources, and simplifies the operating system files restoration procedure since it only requires minimum interaction between the cloud server and client terminal.

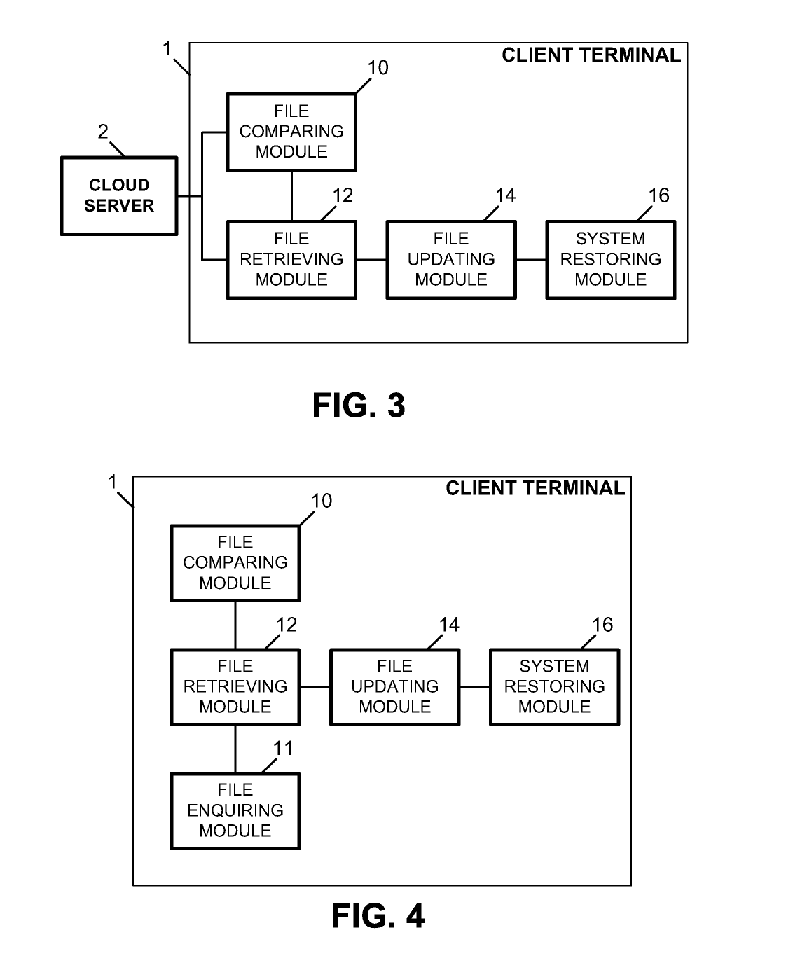

Referring now to FIGS. 3 and 4, an internet system for restoring an operating system of a computer is shown according to one embodiment of the present invention. In the exemplary embodiment, the internet system has a client terminal 1 and a cloud server 2 in communication with the client terminal 1. The cloud server 2 is adapted to store the standard operating system files. The cloud server 2 is also adapted to store user backup operating system files of the client terminal 1. The client terminal 1 includes a file comparing module 10, a file retrieving module 12, a file updating module 14 and a system restoring module 16 coupling to each other. The file comparing module 12 is used to compare the local operating system files of a computer with the standard operating system files stored in the cloud server 1 and to obtain the results of the comparison. As discussed above, the results of the comparison includes information related to the standard operating system files stored in the cloud server that are different from the local operating system files, and information related to the standard operating system files stored in the cloud server that are not part of the local operating system files. The file retrieving module 12 is used to retrieve portions or a complete set of the standard operating system files from the cloud server based on the results of the comparison. The file updating module 14 is used to update the local operating system files of the computer with the standard operating system files retrieved from the cloud server. The system restoring module 16 is used to restore the operating system by reloading the updated local operating system files of the computer.

In addition, the client terminal 1 further includes a file enquiring module 11, as shown in FIG. 4, coupling to the file retrieving module 12. In operation, the file enquiring module 11 enquires whether the cloud server contains any of the user backup operating system files. The file retrieving module 12 retrieves the user backup operating system files from the cloud server when the file enquiring module 11 confirms that the cloud server 2 contains the user backup operating system files. The file updating module 14 then updates the local operating system files of the computer with the user backup operating system files retrieved from the cloud server 2.

In one embodiment, at least one of the file comparing module, the file retrieving module, the file updating module, the file enquiring module and the system restoring module comprises a processor for performing its function.

One aspect of the present invention also provides a client terminal for restoring an operating system of a computer. In one embodiment, as shown in FIGS. 3, and 4, the client terminal a file comparing module 10 configured to compare local operating system files of a computer with the standard operating system files stored in the cloud server 2 and obtaining the results of the comparison, a file retrieving module 12 configured to retrieve portions or a complete set of the standard operating system files from the cloud server 2 based on the results of the comparison, a file updating module 14 configured to update the local operating system files of the computer with the standard operating system files retrieved from the cloud server 2, and a system restoring module 14 configured to restore the operating system by reloading the updated local operating system files of the computer.

The client terminal 1 may also have a file enquiring module 11 configured to enquire whether the cloud server 2 contains user backup operating system files. In operation, the file enquiring module 11 enquires whether the cloud server 2 contains the user backup operating system files, the file retrieving module 12 retrieves the user backup operating system files from the cloud server 2 if the cloud server 2 contains the user backup operating system files, and the file updating module 14 updates the local operating system files of the computer with the user backup operating system files retrieved from the cloud server 2.

The client terminal 1 can be a local computer in which the operating system needs to be restored, or another computer rather than the computer in which the operating system needs to be restored.

Additionally, in use, the client terminal 1 is in communication with the cloud server via any communication protocols, such as internet, intranet, wire and wireless communication protocols, or the like.

Another aspect of the present invention provides a non-transitory tangible computer-readable medium storing instructions or codes which, when executed by a processor, cause a computer to perform a method for restoring an operating system of the computer. The non-transitory tangible computer-readable storage medium includes, but not limited to, disk, CD-ROM, read-only memory (ROM), random memory (RAM), flash dive, or the likes.

As discussed above, the method in one embodiment includes comparing local operating system files of the computer with standard operating system files stored in a cloud server, obtaining results of the comparison, retrieving portions or a complete set of the standard operating system files from the cloud server based on the results of the comparison, updating the local operating system files with the standard operating system files retrieved from the cloud server, and restoring the operating system in the computer by reloading the updated local operating system files.

Further, the method includes, prior to restoring the operating system in the computer by reloading the updated local operating system files, enquiring the cloud server whether to contain user backup files of the local operating system files, retrieving the user backup files from the cloud server if the cloud server contains the user backup files, and updating the local operating system files with the user backup files retrieved from the cloud server.

In one embodiment, the step of obtaining the results of the comparisons includes obtaining information related to the standard operating system files stored in the cloud server that are different from the local operating system files, and information related to the standard operating system files stored in the cloud server that are not part of the local operating system files.

According to embodiments of the invention, the operating system files to be restored in a computer are retrieved from the cloud server. Further, the operating system files to be restored are retrieved based on the results of comparison between the local operating system files installed in the computer and the standard operating system files stored in the cloud server. Accordingly, only those files of the local operating system files that are damaged, added or altered, and those files of the standard operating system files stored in the cloud server that are missed in the local operating system files of the computer are retrieved, thereby reducing the number of files to be retrieved and increasing the efficiency of the operating system restoration without a need of a large storage space from the local computer.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A method for restoring an operating system in a computer, comprising:
(a) comparing local operating system files of the computer with standard operating system files stored in a cloud server;
(b) obtaining results of the comparison;
(c) retrieving portions or a complete set of the standard operating system files from the cloud server based on the results of the comparison;
(d) updating the local operating system files with the standard operating system files retrieved from the cloud server; and
(e) restoring the operating system in the computer by reloading the updated local operating system files,
wherein at least one of steps (a)-(e) is executed by at least one processor from the cloud server or a client terminal in commutation with the cloud server.

2. The method according to claim 1, prior to restoring the operating system in the computer by reloading the updated local operating system files, further comprising:
enquiring the cloud server whether to contain user backup files of the local operating system files;
retrieving the user backup files from the cloud server if the cloud server contains the user backup files; and
updating the local operating system files with the user backup files retrieved from the cloud server.

3. The method according to claim 1, wherein the step of obtaining the results of the comparisons comprises:
obtaining information related to the standard operating system files stored in the cloud server that are different from the local operating system files, and information related to the standard operating system files stored in the cloud server that are not part of the local operating system files.

4. The method according to claim 1, wherein the client terminal is the computer in which the operating system is restored.

5. The method according to claim 1, wherein the client terminal is another computer rather than the computer in which the operating system is restored.

6. A client terminal for restoring an operating system in a computer, comprising:
a file comparing module configured to compare local operating system files of the computer with the standard operating system files stored in a cloud server and obtaining the results of the comparison;
a file retrieving module configured to retrieve portions or a complete set of the standard operating system files from the cloud server based on the results of the comparison;
a file updating module configured to update the local operating system files of the computer with the standard operating system files retrieved from the cloud server; and
a system restoring module configured to restore the operating system by reloading the updated local operating system files of the computer,
wherein at least one of the file comparing module, the file retrieving module, the file updating module and the system restoring module comprises a processor.

7. The client terminal according to claim 6, further comprising a file enquiring module configured to enquire whether the cloud server contains user backup operating system files, and wherein in operation, the file enquiring module enquires whether the cloud server contains the user backup operating system files, the file retrieving module retrieves the user backup operating system files from the cloud server if the cloud server contains the user backup operating system files, and the file updating module updates the local operating system files of the computer with the user backup operating system files retrieved from the cloud server.

8. The client terminal according to claim 6, wherein the results of the comparison obtained by the file comparing module comprise information related to the standard operating system files stored in the cloud server that are different from the local operating system files, and information related to the standard operating system files stored in the cloud server that are not part of the local operating system files.

9. The client terminal according to claim 6, being the computer in which the operating system is restored.

10. The client terminal according to claim 6, being another computer rather than the computer in which the operating system is restored.

11. The client terminal according to claim 6, being in communication with the cloud server via at least one of internet, intranet, wire and wireless communication protocols.

12. An internet system for restoring an operating system in a computer, comprising:
a cloud server storing standard operating system files of a computer operating system, run by one or more processors; and
a client terminal comprising:
a file comparing module configured to compare local operating system files of the computer with the standard operating system files stored in the cloud server and obtaining the results of the comparison;
a file retrieving module configured to retrieve portions or a complete set of the standard operating system files from the cloud server based on the results of the comparison;
a file updating module configured to update the local operating system files of the computer with the standard operating system files retrieved from the cloud server; and
a system restoring module configured to restore the operating system by reloading the updated local operating system files of the computer.

13. The internet system according to claim 12, wherein the cloud server is further adapted to store user backup operating system files of the computer.

14. The internet system according to claim 13, wherein the client terminal further comprises a file enquiring module configured to enquire whether the cloud server contains the user backup operating system files, and wherein in operation, the file enquiring module enquires whether the cloud server contains the user backup operating system files, the file retrieving module retrieves the user backup operating system files from the cloud server if the cloud server contains the user backup operating system files, and the file updating module updates the local operating system files of the computer with the user backup operating system files retrieved from the cloud server.

15. The internet system according to claim 12, wherein the results of the comparison obtained by the file comparing module comprise information related to the standard operating system files stored in the cloud server that are different from the local operating system files, and information related to the standard operating system files stored in the cloud server that are not part of the local operating system files.

16. The internet system according to claim 12, wherein the client terminal is the computer in which the operating system is restored.

17. The internet system according to claim 12, wherein the client terminal is another computer rather than the computer in which the operating system is restored.

18. A computer-readable medium storing instructions which, when executed by a processor, cause a computer to perform a method for restoring an operating system of the computer, the method comprising:
(a) comparing local operating system files of the computer with standard operating system files stored in a cloud server;
(b) obtaining results of the comparison;
(c) retrieving portions or a complete set of the standard operating system files from the cloud server based on the results of the comparison;
(d) updating the local operating system files with the standard operating system files retrieved from the cloud server; and
(e) restoring the operating system in the computer by reloading the updated local operating system files.

19. The computer-readable medium according to claim 18, wherein the method further comprises, prior to restoring the operating system in the computer by reloading the updated local operating system files:
enquiring the cloud server whether to contain user backup files of the local operating system files;
retrieving the user backup files from the cloud server if the cloud server contains the user backup files; and
updating the local operating system files with the user backup files retrieved from the cloud server.

20. The computer-readable medium according to claim 18, wherein the step of obtaining the results of the comparisons comprise:
obtaining information related to the standard operating system files stored in the cloud server that are different from the local operating system files, and information related to the standard operating system files stored in the cloud server that are not part of the local operating system files.
